(19) United States
(12) Patent Application Publication
(10) Pub. No.: US 2006/0056651 A1
(43) Pub. Date: Mar. 16, 2006

(54) Spiral ribbon speaker

(76) Inventor: HongBo Yao, Hong Kong (CN)

Correspondence Address: LAW OFFICES OF CLEMENT CHENG, 17220 NEWHOPE STREET #127, FOUNTAIN VALLEY, CA, 92708, US

(21) Appl. No.: 10/941,481

(22) Filed: Sep. 15, 2004

(51) Int. Cl. H04R 1/00; H04R 9/06

(52) U.S. Cl. 381/399; 381/396

(57) ABSTRACT

A ribbon type high frequency loudspeaker structure has a ring-shaped upper magnetic plate, a ring-shaped magnet, and a lower T-shaped magnetic plate with an inner magnet pole, which form a magnetic path structure. The inner magnet pole of the lower T-shaped magnetic plate is located in the center of the ring of the ring-shaped upper magnetic plate and the ring-shaped magnet. An inter-magnet gap is formed between the outer pole surface of the inner magnet pole and the inner ring surface of the ring-shaped magnet. A flat-type vibration diaphragm is set on the top of the upper magnetic plate said fiat-type vibration diaphragm is formed by molding a spiral-shaped flat coil on the substrate surface of the non-conductive thin film. The flat-type coil is located in the inter-magnet gap between the upper magnetic plate and the lower T-shaped magnetic plate.

### FIELD OF INVENTION

This practical new design relates to one kind of ribbon-type loudspeaker.

### RELATED ART

Currently, the commonly known kind of ribbon-type high frequency loudspeaker is a rectangular mechanism that uses an upper layer and a lower layer of high efficiency magnetic strip to form a magnetic field; sandwiched in the middle in a thin-film, the surface of which is covered with an aluminum ribbon circuit; when an alternating electric current passes through the aluminum ribbon, because of the magnetic field effect, the aluminum ribbon causes the thin film to vibrate up and down which drives the air and creates sound. Because an upper and lower magnetic path structure is adopted, on the sound generation surface the distance from the sound source to the radiation surface is relative longer; furthermore, because a sound groove needs to be placed on the magnetic plate for radiation and there are vertical and horizontal dimensional discrepancies on the vibrating diaphragm, that is why, acoustically, the traditional ribbon-type loudspeaker as a more acute directional nature. Furthermore, singularly, it has very obvious vertical and horizontal directional discrepancies.

### GOAL OF THE INVENTION

The goal of this practical new design is to produce one kind of ribbon-type high frequency loudspeaker that could properly solve the aforementioned problems.

### SUMMARY OF THE INVENTION

The technical plan is as follows: a magnetic structure composed of a ring-shaped upper magnetic plate, a ring-shaped magnet, and a lower T-shaped magnetic plate with an inner magnet pole. The inner magnet pole of the lower T-shaped magnetic plate is located in the center of the ring of the ring-shaped upper magnetic plate and the ring-shaped magnet. An inter-magnet gap is formed between the outer pole surface of said inner magnet pole and the inner ring surface of the ring-shaped magnet. A flat-type diaphragm is set on top of the upper magnetic plate. Molding a spiral-shaped flat coil on the substrate surface of the non-conductive thin diaphragm forms the flat-type diaphragm. The flat-type coil fits in the inter-magnet gap between the upper magnetic plate and the lower T-shaped magnetic plate.

The flat coil can be a layer of outward radiating spiral-shaped aluminum ribbon covering the substrate surface of the thin film.

The following is the best mode. The magnetic gap width between the upper magnetic plate and the lower T-shaped magnetic plate is 1.5˜10 mm. The inner circle chamfer a of the ring-shaped upper magnetic plate is 15°˜85°. The line width of the flat coil is 0.1˜2.6 mm, the gap between the rings is 0.03˜1.5 mm. The thickness of the substrate of the non-conductive thin film of the vibration diaphragm is 0.01-˜0.2 mm. The diameter of the vibration diaphragm is Φ8 mm˜Φ120 mm.

This design uses the improved traditional driver system to drive the ribbon-type vibration diaphragm to create sound. Its vibration diaphragm principle is identical to the traditional ribbon-type vibration diaphragm principle. Structurally, it is changed to a ring; the coil structure is also changed to round shape so that the directional nature on a 360° direction plane is uniform, thereby eliminating the vertical and horizontal discrepancies. As a result of the elimination of the front magnetic strips(s), the vibration diaphragm directly radiates outward, thereby eliminating the interference on the path, allowing it to have a broader direction than traditionally, and effectively solving the problems of traditional design. A critical part of the this loudspeaker is its driver, which uses the structure of a traditional electro-dynamic loudspeaker, utilizing its radiating magnetic field to drive the vibration diaphragm, however, the radiating magnetic field's intensity and uniformity of the outer magnetic path structure of the traditional structure are incapable of meeting the ribbon-type high pitch demand. This practical new design increases the air gap and improves the magnetic mode in the air gap and the inner magnet pole structure making it possible to enhance the intensity and uniformity of the radiating magnetic Field, to enhance the sensitivity of the loudspeaker, to allow the drive to he more even, and to reduce loss of fidelity. Its electro acoustical performance is made capable of meeting the demands for a high fidelity speaker.

### BRIEF DESCRIPTION OF THE DRAWINGS

FIG. 1 is a cross section view of the speaker with outside housing:

FIG. 2 is a top view of the spiral member vibration diaphragm.

FIG. 3 is a perspective view of the upper magnetic plate.

FIG. 4 is an exploded view of the present invention.

FIG. 5 is a longitudinal section view of the ribbon-type high frequency loudspeaker.

FIG. 6 is a frontal view of the spiral member vibration diaphragm.

FIG. 7 is a side view of the present embodiment.

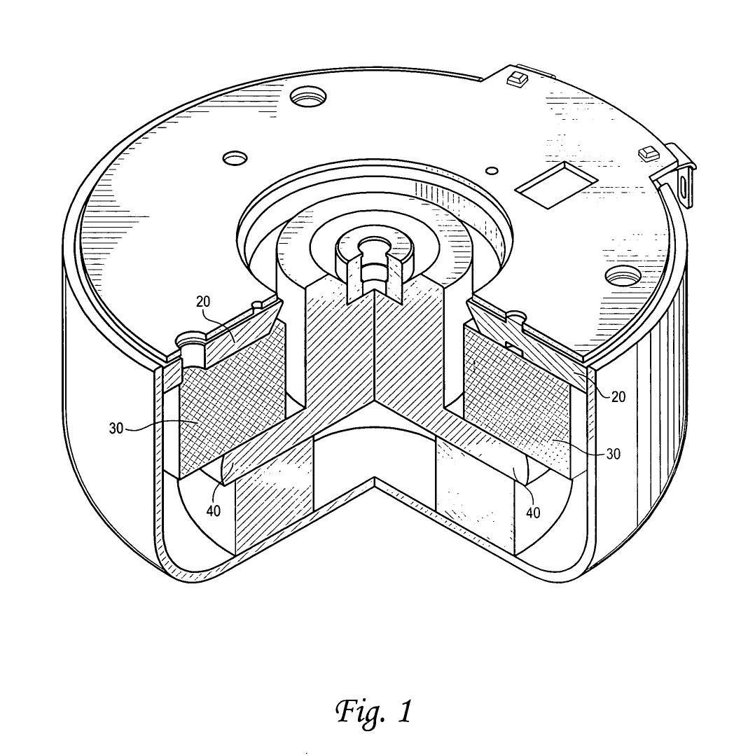

### DETAILED DESCRIPTION OF THE PREFERRED EMBODIMENT

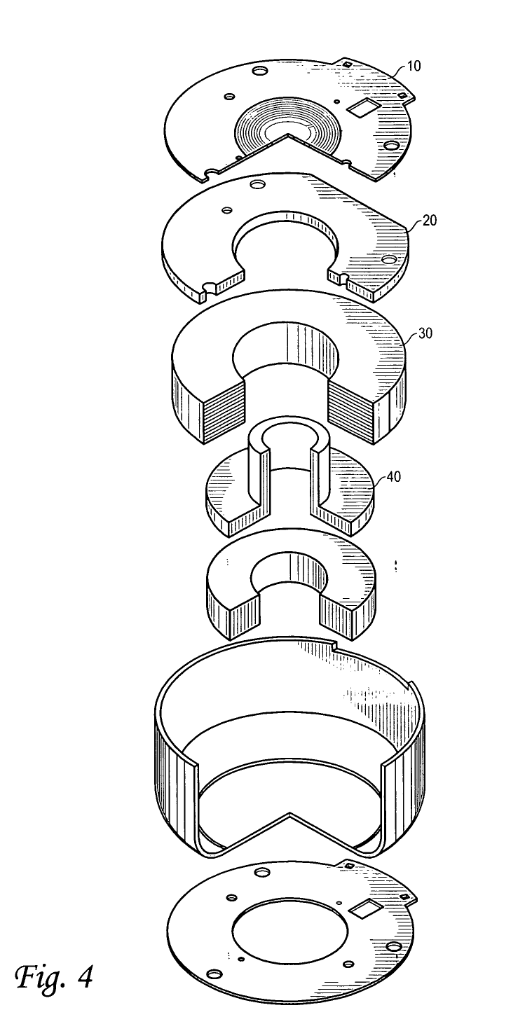

The following, together with the diagrams, further explains the structural details of this practical design. FIG. 4. shows the construction.

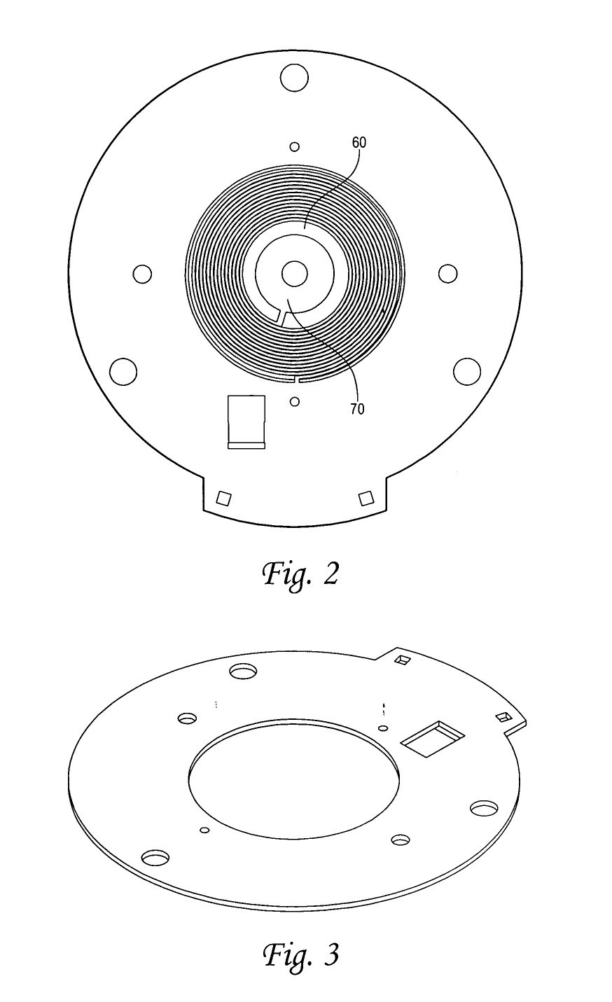

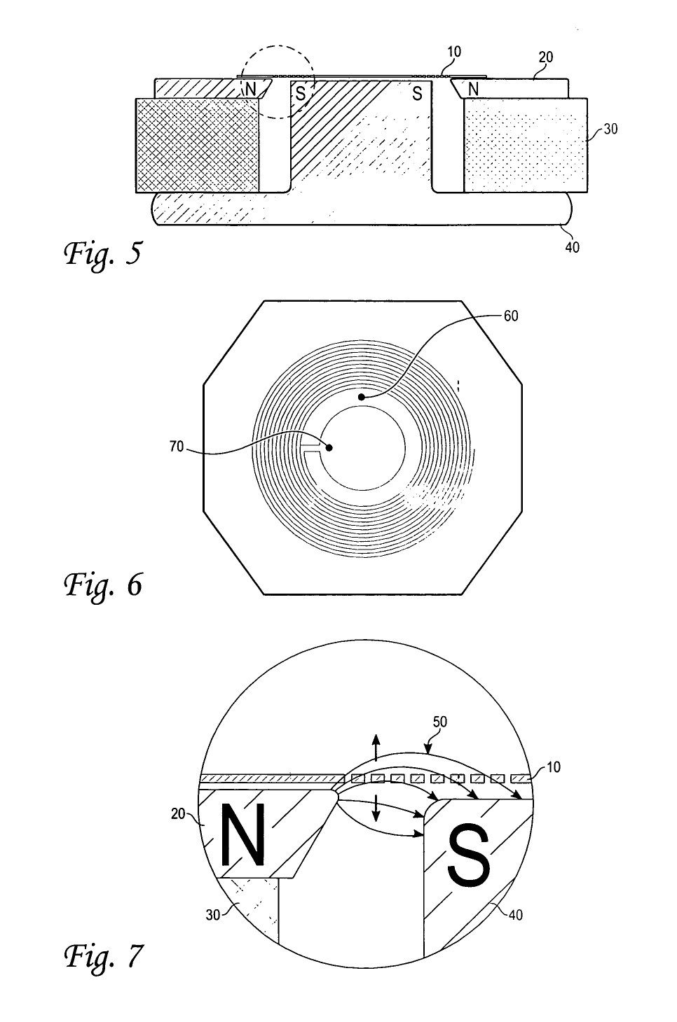

As shown in FIG. 5, the magnetic structure of this ribbon-type high frequency loudspeaker is made up of a ring-shaped upper magnetic plate 20, a ring-shaped magnet 30, and a lower T-shaped magnetic plate with an inner magnet pole 40. The inner magnet pole of the lower T-shaped magnetic plate is located in the ring center of the ring-shaped upper magnetic plate and the ring-shaped magnet. An inter-magnet gap is formed between the outer pole surface of the inner magnet pole and the inner ring surface of the ring-shaped magnet; a flat-type vibration diaphragm is set on the top of the upper magnetic plate as shown in FIG. 2, 6. Placing a layer of outward radiating spiral-shaped aluminum ribbon flat coil on the substrate of the non-conducting thin film forms the structure of the vibration diaphragm. The flat coil is located in the inter-magnet gap between the upper magnetic plate and the lower T-shaped magnetic plate. FIG. 7 shows the direction of the magnetic flow 50 from the N pole 20 to the S pole 40. The magnetic line 50 can be seen passing through the vibration diaphragm conductor 10. At this time, if there is electric current passing through the conductor, the vibration diaphragm will move up and down along with the electric current. Other materials can be used for the vibration diaphragm conductor 10 besides aluminum but aluminum is best.

The best mode is:
1. Upper magnetic plate: outer diameter Φ64 mm, inner diameter Φ28 mm, thickness 3 mm, inner circle chamfer a is 60°.
2. Lower magnetic plate; outer diameter Φ65 mm, plate thickness 4 mm, pole diameter Φ22 mm, pole height 18 mm.
3. Ring-shaped magnetic plate: Φ70 mm, inner diameter Φ32 mm, thickness 15 mm.
4. The thickness of the substrate of the thin film of the vibration diaphragm is 0.02 mm, the line width of the coil is 0.6, the inter-ring gap is 0.1 mm, and the diameter of the vibration diaphragm spiral body is Φ29 mm.

Figure one shows that the permanent magnet 30 has a pair of poles the North Pole influencing the bottom magnetic plate 40 and the top being the South Pole influencing the top magnetic plate 20. This allows a single magnet make a North and South Pole where the North Pole is inside the South Pole.

This forms an outside magnet with a hole and an inside magnet where the inside magnet is small enough to form a magnetic gap between the outside magnet and the inside magnet. The entire structure including the inside magnet, outside magnet and conductive vibrating spiral is shown as cylindrical that can also be made rectangular or in other kinds of shapes such as triangle, square, pentagon, or oval. The poles can be reversed as long as the flat electrically conducting vibrating membrane assembled on the outside magnet and inside magnet is a spiral-shaped flat coil having spirals mounted within the magnetic influence of the inter-magnet gap between the outside magnet and the inside magnet.

Other obvious combinations and variations of the present invention are included in the description and accorded within the scope of the claims.

1. A ribbon-type high frequency loudspeaker, comprising: an upper magnetic plate, a ring-shaped magnet connected to the upper magnetic plate, and a lower T-shaped magnetic plate below the upper magnetic plate connected to the ring-shaped magnet; a flat vibrating membrane assembled on the upper magnetic plate, the vibrating membrane formed by molding a spiral-shaped flat coil on a substrate surface of a non-conductive thin diaphragm, the flat coil located in the inter-magnet gap between the upper magnetic plate and the lower T-shaped magnetic plate.

2. The ribbon-type high frequency loudspeaker of claim 1 wherein the ribbon-type high frequency loudspeaker's special feature is that the flat coil is an outward radiating spiral-shaped aluminum ribbon.

3. The ribbon-type high frequency loudspeaker of claim 2 wherein the ribbon-type high frequency loudspeaker's special feature is that the line width of the fiat coil (7) is 0.1˜2.6 mm, and the gap between the rings is 0.03˜1.5 mm.

4. The ribbon-type high frequency loudspeaker of claim 2 wherein the ribbon-type high frequency loudspeaker's special feature is that the thickness of the substrate of the non-conductive thin film of the vibrating diaphragm (1) is 0.01˜0.2 mm.

5. The ribbon-type high frequency loudspeaker of claim 1 wherein the ribbon-type high frequency loudspeaker's special feature is that the width of the inter-magnet gap between said upper magnetic plate and the lower T-shaped magnetic plate (4) is 1.5˜10 mm.

6. The ribbon-type high frequency loudspeaker of claim 1 wherein the ribbon-type high frequency loudspeaker's special feature is that the described ring-shaped upper magnetic plate (2) has a 15°˜85° inner circle chamfer.

7. The ribbon-type high frequency loudspeaker of claim 1 wherein the ribbon-type high frequency loudspeaker's special feature is that the line width of the described fiat coil (7) is 0.1˜2.6 mm, and the gap between the rings is 0.03˜1.5 mm.

8. The ribbon-type high frequency loudspeaker of claim 1 wherein the ribbon-type high frequency loudspeaker's special feature is that the thickness of the substrate of the non-conductive thin film of the vibrating diaphragm (1) is 0.01˜0.2 mm.

9. The ribbon-type high frequency loudspeaker of claim 1 wherein the ribbon-type high frequency loudspeaker's special feature is that the coil is a spiral-shaped ribbon.

10. A ribbon-type high frequency loudspeaker, comprising: an upper magnetic plate, and a lower magnetic plate below the upper magnetic plate; a flat vibrating membrane assembled on the upper magnetic plate, the vibrating membrane formed by molding a spiral-shaped flat coil on a substrate surface of a non-conductive thin diaphragm, the flat coil located in the inter-magnet gap between the upper magnetic plate and the lower magnetic plate.

11. The ribbon-type high frequency loudspeaker of claim 10 wherein the ribbon-type high frequency loudspeaker's special feature is that the flat coil is an outward radiating spiral-shaped aluminum ribbon.

12. The ribbon-type high frequency loudspeaker of claim 10 wherein the ribbon-type high frequency loudspeaker's special feature is that the line width of the described fiat coil (7) is 0.1˜2.6 mm, and the gap between the rings is 0.03˜1.5 mm.

13. The ribbon-type high frequency loudspeaker of claim 10 wherein the ribbon-type high frequency loudspeaker's special feature is that the thickness of the substrate of the non-conductive thin film of the vibrating diaphragm (1) is 0.01˜0.2 mm.

14. The ribbon-type high frequency loudspeaker of claim 10 wherein the ribbon-type high frequency loudspeaker's special feature is that the coil is a spiral-shaped ribbon.

15. A ribbon-type high frequency loudspeaker, comprising:
a. an outside magnet, having a hole;
b. an inside magnet, fitting inside the hole and wherein an inter-magnet gap forms between the outside magnet and inside magnet;
c. a flat electrically conducting vibrating membrane assembled on the outside magnet and inside magnet is a spiral-shaped flat coil having spirals mounted within the magnetic influence of the inter-magnet gap between the outside magnet and the inside magnet.
